(19) United States
(12) Patent Application Publication
(10) Pub. No.: US 2010/0311428 A1
(43) Pub. Date: Dec. 9, 2010

(54) RANDOM ACCESS PREAMBLE CELLULAR PHONE SYSTEMS WITH MULTIPLE ZADOFF-CHU SEQUENCES

(76) Inventors: Xiaobo Zhang, Shanghai (CN); Ni Ma, Shanghai (CN); Gang Wu, Shanghai (CN)

Correspondence Address: Docket Clerk, P.O. Box 802432, Dallas, TX, 75380, US

(21) Appl. No.: 12/733,710

(22) PCT Filed: Sep. 15, 2008
(86) PCT No.: PCT/IB2008/053722

§ 371 Date: Aug. 25, 2010

(30) Foreign Application Priority Data
Sep. 18, 2007 (CN) 200710151280.6

(51) Int. Cl. H04W 74/00

(52) U.S. Cl. 455/447

(57) ABSTRACT

A cellular phone system where a random access channel burst has a preamble comprising two Zadoff-Chu sequences to mitigate the effects of Doppler Frequency Offset. Upon reception of a random access channel burst by a base station, division is applied to the two sequences recovered from the preamble of the received burst to provide a quotient sequence. For some embodiments, the base station correlates the quotient sequence with a Zadoff- Chu sequence to identify the user equipment that transmitted the random access channel burst. Other embodiments are described and claimed.

### FIELD

The present invention relates to communication systems, more particularly to cellular phone systems, and more particularly to preambles for random access attempts in cellular phone systems.

### BACKGROUND

A mobile cellular phone system re-uses frequency spectrum by dividing spatial coverage into cells, each cell re-using the same frequency spectrum. FIG. 1 illustrates this in simple fashion, showing cell 102 with base station (BS) 104 and user equipment (UE) 106A, 106B, and 106C. In practice, a UE is a communication device making use of cellular phone technology, such as for example a cell phone, or a computer with a wireless card. A UE may be stationary, or may be in a moving vehicle. for simplicity, only three UEs are illustrated in cell 102, but in practice there will be a much larger number of such devices within any single cell.

Various signaling schemes may be employed to allow multiple UEs sharing a cell to communicate with a BS in the cell. Examples include TDMA (Time Division Multiple Access), FDMA (Frequency Division Multiple Access), CDMA (Code Division Multiple Access), and OFDMA (Orthogonal Frequency Division Multiple Access), to name a few. Some systems may utilize one signaling scheme for downlink communication (BS to UE), and another signaling scheme for uplink communication (UE to BS). Furthermore, a system may utilize different signaling schemes depending upon the information exchanged between a UE and a BS. For example, setting up a call between a UE and a BS may utilize a different signaling scheme than for the case in which the call has already been set up and voice or data content is in the process of being exchanged.

Current and future-contemplated cellular phone systems make use of a random access channel (RACH). A RACH is a contention-based communication channel, used to carry random access transmissions. For some cellular systems, the RACH channel may use the ALOHA protocol. However, other contention-based protocols may be used. The RACH channel when discussed at the physical layer (PHY) level may be referred to as a PRACH (Physical Random Access Channel).

A RACH channel may be used when a UE wishes to set up a connection with the BS in order to place an outgoing call. The RACH channel may be used for various signal processing purposes, such as for timing adjustments (synchronization), power adjustments, and resource requests, to name just a few. As a specific example, power adjustment may make use of the so-called open-loop power control protocol. In this protocol, a UE transmits a preamble to the BS, and if the BS does not acknowledge the preamble, then the UE transmits the preamble again, but at a higher power. This process continues until the received signal strength at the BS is strong enough for reception, at which point the BS sends an acknowledgement to the UE. Future RACH channels may utilize other protocols for power adjustment.

A PRACH burst comprises a random access (RA) preamble to identify the random access attempt. A RA preamble comprises a signature and a cyclic prefix, where the cyclic prefix is appended to the signature to help mitigate ICI (Inter-Channel Interference) and ISI (Inter-Symbol Interference). A UE may choose a specific RA preamble based upon a contention-based protocol. It has been proposed in the 3GPP LTE (3rd Generation Partnership Project Long Term Evolution) specification that a Zadoff-Chu (ZC) sequence is to be used for a RA signature. 3GPP is a collaboration agreement established in December 1998 for the purpose of establishing a specification for the 3G (3^{rd} Generation) mobile phone system. 3GPP LTE is a project within the 3GPP to improve the UMTS (Universal Mobile Telecommunication System) mobile phone standard. See http://www.3gpp.org.

A mobile UE is subject to a Doppler frequency offset (DFO) when moving relative to the BS. For a high mobility UE, the resulting DFO may cause unacceptable detection errors in decoding the ZC sequences, resulting in a high false alarm rate. Some repetition-based schemes have been proposed in order to improve detection performance, but it is believed that such schemes do not completely overcome the DFO problem, especially under relatively severe DFO conditions.

### SUMMARY

As described in the Description of Embodiments, for each ZC sequence there is associated a sequence index. For an embodiment UE, in a RACH burst for a random access attempt, the preamble in the RACH burst comprises two ZC sequences, where the difference in the sequence indices for the two ZC sequences identifies the UE of the random access attempt. For an embodiment BS receiving the RACH burst, two sequences are recovered from the preamble, and are divided to provide a quotient sequence. If the quotient sequence is a ZC sequence, then the sequence index for the quotient sequence identifies the random access attempt. Other embodiments may identify a random access attempt in other ways.

This summary is provided to introduce a selection of concepts in a simplified form that are further described below in the description of embodiments. this summary is not intended to identify key features or essential features of the claimed subject matter, nor is it intended to be used to limit the scope of the claimed subject matter.

### BRIEF DESCRIPTION OF THE DRAWINGS

FIG. 1 illustrates a prior art cellular phone system.

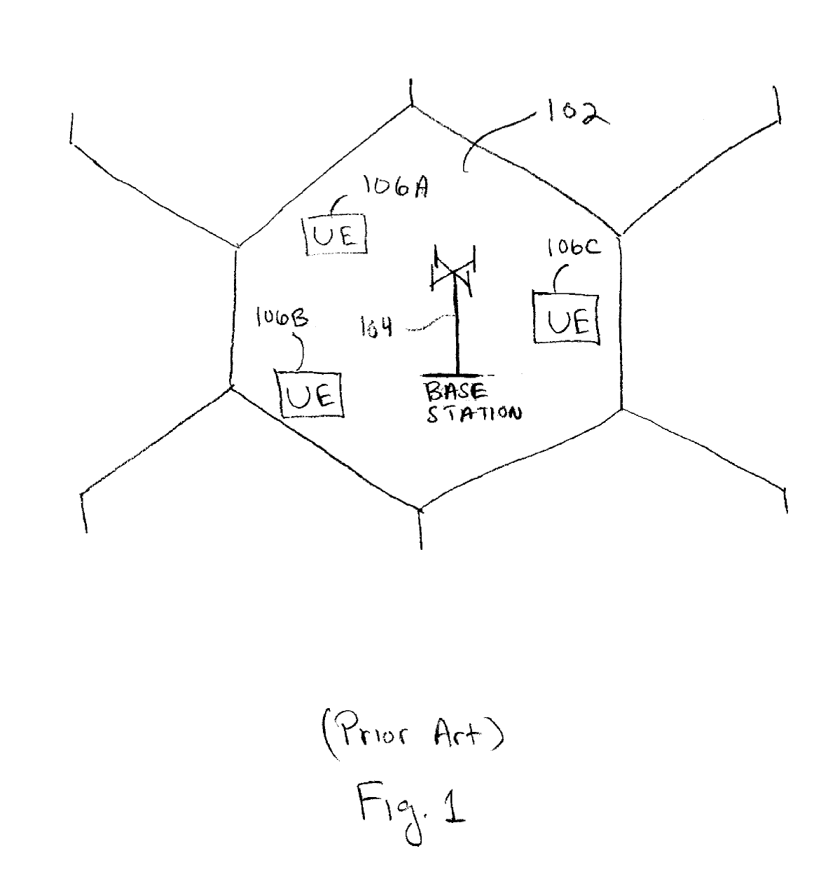

FIG. 2 illustrates protocol stacks for a UE and a BS, and a preamble structure, according to an embodiment of the present invention.

FIG. 3 illustrates a flow diagram according to an embodiment of the present invention.

FIG. 4 illustrates a flow diagram according to another embodiment of the present invention.

### DESCRIPTION OF EMBODIMENTS

In the description that follows, the scope of the term “some embodiments” is not to be so limited as to mean more than one embodiment, but rather, the scope may include one embodiment, more than one embodiment, or perhaps all embodiments.

Before describing the embodiments, a ZC sequence is described. A ZC sequence of length N may be represented as {aᵤ(k), k=0, 1,, . . . N−1}), where u is an index, u=0, 1, . . . , N−1, and may be referred to as the sequence index. A ZC sequence {aᵤ(k), k=0, 1, . . . , N−1} may be generated by the expression

$${a}_{u} ( k ) = exp ( - jπ u \frac{k ( k + 1 )}{N} ) , k = 0 , 1 , … , N - 1.$$

From the above expression, it is seen that aᵤ(k) is periodic in the index u with a period equal to N. It is also readily observed from the above expression that the DFT (Discrete Fourier Transform) of a ZC sequence is another ZC sequence. That is, the DFT maps a ZC sequence into another ZC sequence of the same length. Consequently, the properties of the ZC sequences are the same whether considered in the time domain or in the frequency domain. For notational convenience, the ZC sequence {aᵤ(k), k=0, 1, . . . , N−1) will be denoted by aᵤ.

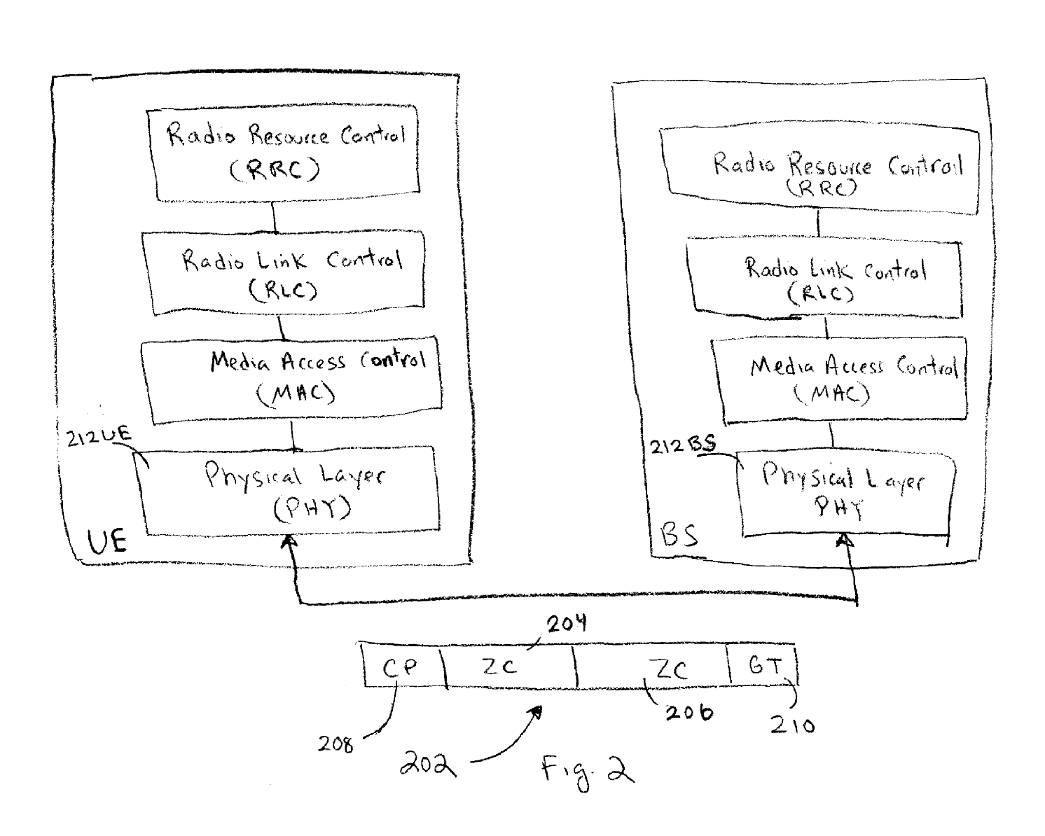

Embodiments may be described with respect to the simplified protocol stack illustrated in FIG. 2, where a PRACH burst, labeled 202, is illustrated having a preamble comprising two ZC sequences, labeled 204 and 206. In addition to the two ZC sequences, PRACH burst 202 comprises cyclic prefix 208 and guard time 210. During guard time 210, PRACH burst 202 has no transmission. Embodiments may be implemented at the physical layer of a UE, labeled PHY layer 212UE, to provide bursts with preambles comprising two ZC sequences; and embodiments may be implemented at the physical layer of a BS, labeled PHY layer 212BS, to recover the preamble so as to identify the random access attempt. Some or all of the functions of a physical layer in either a UE or BS may be implemented by one or more ASICs (Application Specific Integrated Circuit), or by a FPGA (Field Programmable Gate Array), to name two examples.

From its definition, a ZC sequence is a sequence of complex numbers. As is well known, a complex number may be transmitted over a channel in the sense that its real component modulates the in-phase component of a bandpass signal, and the imaginary component modulates the quadrature component of the bandpass signal. Demodulation recovers the inphase and quadrature components. In the case of OFDMA, an IDFT (Inverse Discrete Fourier Transform) is performed on the ZC sequences making up a UE RACH burst, followed by cyclic prefix insertion, and then up-conversion to an RF (Radio Frequency) carrier. Upon reception, the RF signal is down-converted to a baseband signal (complex-valued with in-phase and quadrature components), the cyclic prefix is removed, and a DFT is performed to recover the ZC sequences.

ZC sequences 204 and 206 in RACH burst 202 of FIG. 2 may be represented, respectively, by aᵤ₁ and aᵤ₂. That is,

$${a}_{u 1} ( k ) = exp ( - jπ {u}_{1} \frac{k ( k + 1 )}{N} ) , k = 0 , 1 , … , N - 1 , \\ and$$

$${a}_{u 2} ( k ) = exp ( - jπ {u}_{2} \frac{k ( k + 1 )}{N} ) , k = 0 , 1 , … , N - 1.$$

To avoid a subscript to a subscript, the index u₁ is written as u1 when serving as a subscript to ZC sequence 204. A similar remark applies to u₂ and ZC sequence 206.

For a RACH burst having a preamble comprising the ZC sequences aᵤ₁ and aᵤ₂, let âᵤ₁ denote the sequence at a BS recovered from the ZC sequence aᵤ₁, and let âᵤ₂ denote the sequence at the BS recovered from the ZC sequence aᵤ₂.

According to some embodiments, the preamble for a UE RACH burst comprises two ZC sequences with sequence indices u₁ and u₂ such that 0≦u₁−u₂≦N−1, where the difference Δu≡u₁−u₂ identifies the UE RACH random access. At the BS, each term of the recovered sequence âᵤ₁ is divided by a corresponding term of the recovered sequence âᵤ₂ to yield a quotient sequence. If this quotient sequence yields a ZC sequence, then the index of the resulting quotient sequence is identified with Δu, and the random access attempt is thereby identified. In other words, if for each k=0, 1, . . . , N−1, the quotient

$$q ( k ) ≡ \frac{{\hat{a}}_{u 1} ( k )}{{\hat{a}}_{u 2} ( k )}$$

is such that q(k)=a_{υ}(k), where {a_{υ}(k), k=0, 1, . . . , N−1} is a ZC sequence of index v, then the difference Δu identifying the UE RACH random access is estimated as Δu=v.

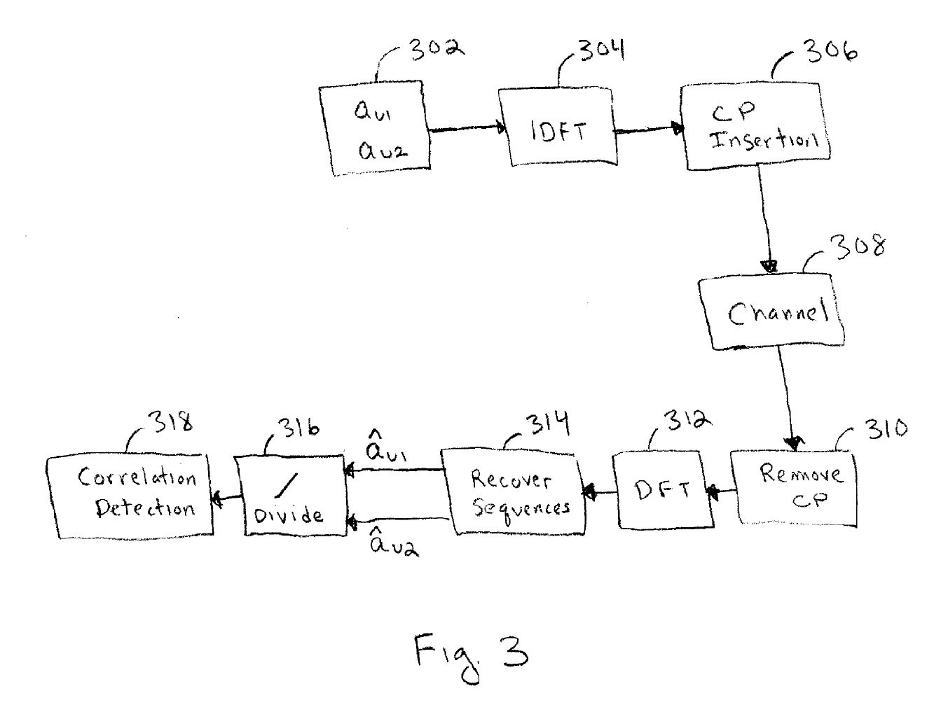

The above description may be represented by the diagram of FIG. 3. The functions indicated by 302, 304, and 306 are performed by the UE. Two ZC sequences are generated (302) at the UE, denoted as aᵤ₁ and aᵤ₂, followed by an IDFT (304). A cyclic prefix is inserted (306) after the preamble comprising aᵤ₁ and aᵤ₂, and the RACH burst is transmitted over channel 308. The functions indicated by 310, 312, 314, 316, and 318 are performed by the BS. The cyclic prefix is removed (312), followed by a DFT (312). The sequences âᵤ₁ and âᵤ₂ are recovered (314). A division is performed (316) with âᵤ₁ the dividend and âᵤ₂ the divisor. Correlation Detection 318 identifies the resulting quotient as a ZC sequence, and the index of the quotient ZC sequence indentifies the UE random access.

It is expected that the above-described embodiments help mitigate DFO in the identification of a UE random access. This may be shown as follows. For an ideal OFDMA channel (noiseless and without ISI and ICI), the received sequences due to DFO may be expressed as

$${\hat{a}}_{u 2} ( k ) = exp ( - jπ {u}_{2} \frac{k ( k + 1 )}{N} ) exp ( j2πΔ f \frac{kT}{N} ) , k = 0 , 1 , … , N , \\ and$$

$${\hat{a}}_{u 2} ( k ) = exp ( - jπ {u}_{2} \frac{k ( k + 1 )}{N} ) exp ( j2πΔ f \frac{kT}{N} ) , k = 0 , 1 , … , N ,$$

where Δf is the frequency offset due to the Doppler shift in frequency and T is the length (in time) of a ZC sequence. The above expressions assume that the relative velocity of the UE to the BS is substantially constant over the signal time duration T. Dividing âᵤ₁(k) by âᵤ₂(k) for each k=0, 1, . . . , N, yields the quotient sequence q, where

$$q ( k ) ≡ \frac{{\hat{a}}_{u 2} ( k )}{{\hat{a}}_{u 2} ( k )} = exp ( - jπΔ u \frac{k ( k + 1 )}{N} ) = {a}_{u 1 - u 2} ( k ) = {a}_{Δ u} , k = 0 , 1 , … , N .$$

The phase factors

$$exp ( j 2 πΔ u \frac{k T}{N} ) , k = 0 , 1 , … , N ,$$

in the expressions for âᵤ₁ and âᵤ₂ due to DFO are seen to cancel out upon division, so that the quotient sequence q is readily identified with the ZC sequence a_{Δu}. Furthermore, because the smallest period of each ZC sequence is N, and because the difference in sequence indices Δu is chosen by the UE to belong to the set of integers [0, N−1], the UE random access is identified without ambiguity.

For a given preamble overhead, the above-described embodiment trades off the number of unambiguous preambles against the effects of DFO. For example, if the length of a preamble in symbols is denoted by Nₚ, then prior art systems using a single ZC sequence of length Nₚ allow for Nₚ unambiguous UE RACH random accesses in a cell, but at the expense of sensitivity to DFO. By using two ZC sequences in a preamble as in the above-described embodiment, the length of each ZC sequence is

$$\frac{{N}_{p}}{2}$$

(assuming for ease of discussion that Nₚ is even) so that

$$\frac{{N}_{p}}{2}$$

unambiguous UE RACH random accesses may be accommodated, but it is expected that such embodiments have greater robustness against the effects of DFO.

By using more than two ZC sequences in a preamble, a larger number of unambiguous random accesses in a cell may be accommodated, but false alarm rates may go up for such shorter ZC sequences. For example, some embodiments may be designed to have three ZC sequences, say aᵤ₁, aᵤ₂, and aᵤ₃, and two quotient sequences may be derived,

$$\frac{{q}_{Δ u 1} = {\hat{a}}_{u 1}}{{\hat{a}}_{u 2}} and \frac{{q}_{Δ u 2} = {\hat{a}}_{u 2}}{{\hat{a}}_{u 3}} .$$

The second sequence index difference, Δu₂, allows for additional degrees of freedom in identifying a UE RACH random access. However, the length of each ZC sequence is now reduced to (assuming Nₚ is odd)

$$\frac{{N}_{p}}{3} ,$$

which increases the false alarm rate for a particular ZC sequence. Consequently, such types of embodiments trade off the number of allowable unambiguous random accesses against the undesirable properties of shorter ZC sequences.

Some embodiments increase the number of unambiguous RACH random accesses without increasing the number of ZC sequences in a preamble. An embodiment may be described as follows. The first (in the sense of counting from left to right in the burst 202) ZC sequence in a preamble is chosen as either a₀ or

$${a}_{\frac{N}{2}} .$$

(For ease of discussion, N is assumed to be even. It should be clear from the discussion how to modify the description to handle the case of N odd.) If a₀ is chosen, then the second ZC sequence in the preamble is aᵤ where u∈ [0, N−1]. If

$${a}_{\frac{N}{2}}$$

is chosen for the first ZC sequence, then the second ZC sequence in the preamble is aᵤ but where now

$$u ∈ [ \frac{N}{2} , N - 1 ] .$$

In other words, in the former case where a₀ is chosen for the first ZC sequence, the difference in sequence indices between the first and second ZC sequences may take on the values Δu=0, 1, . . . , N−1; whereas in the later case when

$${a}_{\frac{N}{2}}$$

is chosen for the first ZC sequence, the difference in sequence indices between the first and second ZC sequences may take on the values

$$Δ u = 0 , 1 , … , ( \frac{N}{2} ) - 1.$$

The BS provides the quotients

$$q ( k ) ≡ \frac{{\hat{a}}_{u 1} ( k )}{{\hat{a}}_{u 2} ( k )}$$

for each k as before, but also the BS differentiates between the two cases of whether a₀ or

$${a}_{\frac{N}{2}}$$

was chosen as the first ZC sequence by performing a correlation detection on âᵤ₁. Because a₀ or

$${a}_{\frac{N}{2}}$$

are at maximum separation in sequence index space, correlation detection is in general enhanced compared to choosing two ZC sequences from a pair spaced closer than N/2 in index space. The number of unambiguous random accesses is N for the case in which a₀ is chosen for the first ZC sequence, and the number of unambiguous random accesses is N/2 for the case in which

$${a}_{\frac{N}{2}}$$

is chosen for the first ZC sequence. Consequently, the total number of unambiguous random accesses for the above-described embodiment is

$$\frac{3 N}{2} .$$

Note that if upon dividing

$$\frac{{\hat{a}}_{u 1} ( k )}{{\hat{a}}_{u 2} ( k )}$$

it is determined that

$$Δ u ∈ [ \frac{N}{2} , N - 1 ] ,$$

then the first ZC sequence may be determined to be a₀ without correlating âᵤ₁ with a₀.

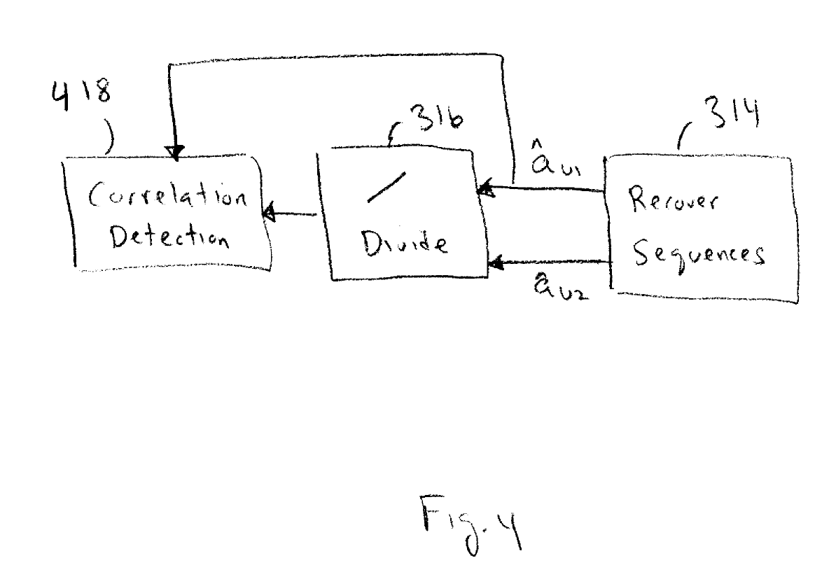

The embodiment illustrated in FIG. 3 may be modified as shown in FIG. 4. (For simplicity, not all elements in FIG. 3 need be reproduced in FIG. 4.) In addition to the signal processing chain indicated by FIG. 3, in FIG. 4 the first recovered sequence âᵤ₁ is also made available to Correlation Detection 418. If Correlation Detection 418 determines that Δu is in the set of integers

$$[ \frac{N}{2} , N - 1 ] ,$$

then the RACH random access burst is identified with a sequence index difference of Δu and with the case where a₀ is the first ZC sequence in the preamble. If, however, Δu is determined to be in the set of integers [0, (N/2)−1], then Correlation Detection 418 also determines whether âᵤ₁ is a₀ or

$${a}_{\frac{N}{2}} .$$

Correlation Detection 418 may then distinguish among the two cases of whether the first ZC sequence in the transmitted burst is a₀ or

$${a}_{\frac{N}{2}} ,$$

and consequently the RACH burst may be unambiguously identified.

Various modifications may be made to the described embodiments without departing from the scope of the invention as claimed below. For example, in the above-described embodiments, the first ZC sequence in a preamble was defined as the first (in order) sequence in a preamble when reading from left to right as shown in burst 202 in FIG. 2. However, this was merely chosen for convenience. Other embodiments may be described in which the “first” ZC sequence is the second (in order) sequence in a preamble, and the “second” ZC sequence is the first (in order) sequence in the preamble.

Furthermore, it should be appreciated that the ZC sequences are periodic in their sequence indices, with a period equal to N. This implies that aᵤ=aᵤ if u is congruent to modulo N. Accordingly, in describing the embodiments, the sequence indices may be restricted to the set of integers [0, N−1] without loss of generality when describing ZC sequences. With this in mind, the embodiment of FIG. 3 may be generalized to where the difference Δu may be chosen from a set S of N integers, where no two integers in the set S are congruent modulo N to each other.

Another modification of the embodiments that follow from the periodicity of the sequence index is to note that the embodiment illustrated in FIG. 4 may be described in more generalized terms where the first and second ZC sequences in a preamble may be chosen from the pair (aᵤ, aᵥ), where u−v is congruent to N/2 modulo N. That is, the first and second ZC sequences are separated in index space by N/2. Furthermore, it is not necessary that these two ZC sequences be separated in index space by N/2. For example, for N even, the two candidate ZC sequences may be separated in index space by some number other than N/2, but a separation of N/2 is expected to have better performance. Note that for N odd, for some embodiments the separation in index space may be

$$\frac{N - 1}{2} or \frac{N + 1}{2} ,$$

as well as other values for other embodiments.

Throughout the description of the embodiments, various mathematical relationships are used to describe relationships among one or more quantities. For example, a mathematical relationship or mathematical transformation may express a relationship by which a quantity is derived from one or more other quantities by way of various mathematical operations, such as addition, subtraction, multiplication, division, etc. Or, a mathematical relationship may indicate that a quantity is larger, smaller, or equal to another quantity. These relationships and transformations are in practice not satisfied exactly, and should therefore be interpreted as “designed for” relationships and transformations. One of ordinary skill in the art may design various working embodiments to satisfy various mathematical relationships or transformations, but these relationships or transformations can only be met within the tolerances of the technology available to the practitioner.

Accordingly, in the following claims, it is to be understood that claimed mathematical relationships or transformations can in practice only be met within the tolerances or precision of the technology available to the practitioner, and that the scope of the claimed subject matter includes those embodiments that substantially satisfy the mathematical relationships or transformations so claimed.

Although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims.

1. An apparatus comprising:
a physical layer to transmit a burst comprising a preamble, the preamble comprising a first Zadoff-Chu sequence and a second Zadoff-Chu sequence, each having a length N, the first Zadoff-Chu sequence periodic in a first sequence index with period equal to N, and the second Zadoff-Chu sequence periodic in a second sequence index with period equal to N.

2. The apparatus as set forth in claim 1, wherein a difference of the first and second sequence indices is an integer selected from a set of N integers such that no two integers in the set of N integers are congruent modulo N to each other.

3. The apparatus as set forth in claim 2, wherein the set of N integers is [0, N−1].

4. The apparatus as set forth in claim 1, wherein the first Zadoff-Chu sequence is chosen from a pre-selected pair of Zadoff-Chu sequences.

5. The apparatus as set forth in claim 4, the pre-selected pair of Zadoff-Chu sequences comprising a first candidate Zadoff-Chu sequence having a first candidate sequence index, and a second candidate Zadoff-Chu sequence having a second candidate sequence index, where for N even the difference in the first and second candidate sequence indices is congruent to N/2 modulo N.

6. The apparatus as set forth in claim 5, where the first candidate sequence index is equal to 0 and the second candidate sequence index is equal to N/2.

7. The apparatus as set forth in claim 6, wherein a first difference of the first candidate sequence index and the second sequence index, and a second difference of the first candidate sequence index and the second sequence index, are integers selected from a set of N integers such that no two integers in the set of N integers are congruent modulo N to each other.

8. The apparatus as set for in claim 4, wherein the pair of Zadoff-Chu sequences comprises a first candidate Zadoff-Chu sequence having a first candidate sequence index, and a second candidate Zadoff-Chu sequence having a second candidate sequence index, where for N odd the difference in the first and second candidate sequence indices is congruent to either
$$\frac{N - 1}{2}$$
modulo N or to
$$\frac{N + 1}{2}$$
modulo N.

9. The apparatus as set forth in claim 8, where the first candidate sequence index is equal to 0 and the second candidate sequence index is equal to
$$\frac{N - 1}{2} or \frac{N + 1}{2} .$$

10. The apparatus as set forth in claim 9, wherein a first difference of the first candidate sequence index and the second sequence index, and a second difference of the first candidate sequence index and the second sequence index, are integers selected from a set of N integers such that no two integers in the set of N integers are congruent modulo N to each other.

11. An apparatus comprising:
a physical layer to receive a burst comprising a preamble, and to recover from the preamble a first sequence having a length N, and a second sequence having a length N; and
a divider to divide term by term the first sequence by the second sequence to provide a quotient sequence having a length N.

12. The apparatus as set forth in claim 11, further comprising:
a correlation detection unit to correlate the quotient sequence with a Zadoff-Chu sequence of length N and periodic in a sequence index with period equal to N.

13. The apparatus as set forth in claim 12, wherein the correlation detection unit further correlates the first sequence with a second Zadoff-Chu sequence of length N chosen from a pre-selected pair of Zadoff-Chu sequences.

14. The apparatus as set forth in claim 13, wherein the pre-selected pair of Zadoff-Chu sequences comprises a first candidate Zadoff-Chu sequence of length N and with a first candidate sequence index, and a second candidate Zadoff-Chu sequence of length N and with a second candidate sequence index, wherein for even N the difference in the first and second candidate sequence indices is congruent modulo N to N/2 and for odd N the difference in the first and second candidate sequence indices is congruent modulo N to either
$$\frac{N - 1}{2} or \frac{N - 1}{2} .$$

15. A method comprising:
transmitting a burst comprising a preamble, the preamble comprising a first Zadoff-Chu sequence and a second Zadoff-Chu sequence, each having a length N, the first Zadoff-Chu sequence periodic in a first sequence index with period equal to N, and the second Zadoff-Chu sequence periodic in a second sequence index with period equal to N.

16. The method as set forth in claim 15, further comprising:
recovering from the preamble a first sequence having a length N, and a second sequence having a length N; and
dividing term by term the first sequence by the second sequence to provide a quotient sequence having a length N.

17. The method as set forth in claim 16, further comprising:
correlating the quotient sequence with a Zadoff-Chu sequence of length N.

18. The method as set forth in claim 17, further comprising:
correlating the first sequence with a second Zadoff-Chu sequence of length N chosen from a pre-selected pair of Zadoff-Chu sequences.

19. The method as set forth in claim 15, wherein a difference of the first and second sequence indices is an integer selected from a set of N integers such that no two integers in the set of N integers are congruent modulo N to each other.

20. The apparatus as set forth in claim 19, wherein the set of N integers is [0, N−1].
